(19) United States
(12) Patent Application Publication
(10) Pub. No.: US 2025/0277992 A1
(43) Pub. Date: Sep. 4, 2025

(54) EYEWEAR ASSEMBLY

(71) Applicant: Benoit M. RATTELADE, Nepean (CA)

(72) Inventor: Benoit M. RATTELADE, Nepean (CA)

(21) Appl. No.: 18/594,131

(22) Filed: Mar. 4, 2024

(51) Int. Cl. G02C 9/04; G02C 7/08; G02C 7/10; G02C 13/00

(52) U.S. Cl. CPC G02C 9/04; G02C 7/086; G02C 7/10; G02C 13/001; G02C 2200/02

(57) ABSTRACT

An eyewear assembly including primary lenses in the form of eyeglasses, secondary lenses engageable with the eyeglasses, and a connector assembly. The secondary lenses may be sunglasses or any of a range of therapeutic lenses other than sunglasses. The connector assembly includes a magnetic member and a non-magnetic member. The magnetic member is provided in one of the primary and secondary lenses, and the non-magnetic member is provided in the other of the primary and secondary lenses. Each magnetic member attracts the associated non-magnetic member to itself when the secondary lenses are brought into close enough proximity to the primary lenses. The magnetic and non-magnetic members thereby detachably retain the primary and secondary lenses in engagement with one another.

### TECHNICAL FIELD

The present disclosure is directed to eyewear. More particularly, the present disclosure relates to an eyewear assembly which includes primary lenses and secondary lenses. Specifically, the disclosure is directed to an eyewear assembly which includes primary lenses in the form of eyeglasses, a secondary lenses which are engageble with the eyeglasses, and a connector assembly. The secondary lenses may be sunglass lenses or any one of a range of therapeutic lenses for concussion, migraine etc. that are a specified tint not used for sunglasses. Others secondary lenses could include a filter for blue light emitted by monitors, clear, sunglass bifocals and readers for presbyopic people. The connector assembly includes a magnetic member and a non-magnetic member. The magnetic member is provided in one of the primary and secondary lenses, and the non-magnetic member is provided in the other of the primary and secondary lenses. The magnet attracts the non-magnetic member to itself when the secondary lenses are brought into close enough proximity to the primary lenses. The magnetic and non-magnetic members detachably retain the primary and secondary lenses in engagement with one another.

### BACKGROUND ART

It is known in the art to provide sunglasses with tinted prescription lenses which are able to be used in bright light conditions instead of regular prescription eyeglasses. It is further known in the art to provide a substitute for tinted prescription lens sunglasses by providing non-prescription lens sunglasses which are selectively engaged in some fashion with prescription eyeglasses. The sunglasses may, for example, be of type that can be clipped onto a frame of the eyeglasses to form an eyewear assembly that can then be used in bright light conditions. The eyewear assembly allows users to wear their prescription eyeglasses but offers a lower cost option than would be the case if the person had to purchase separate prescription sunglasses. Detachable sunglasses also enable users to own multiple pairs of different style sunglasses simply by replacing one clip-on set with another. Stock clip-on sunglasses are readily available but typically do not fit existing frames very well. Furthermore, they tend to come in limited colors of lenses and chassis. Custom-made clip-on sunglasses are readily available at higher cost than stock clip-on sunglasses. These more expensive clip-ons are customized in a variety of ways and are attachable to existing prescription glasses in a variety of ways. Most of these attachment systems require special components to be made to order by the supplier. They tend to be difficult for an optician or optometrist to assemble and many are not durable.

Other methods of attaching sunglasses to eyeglasses are known including providing magnets on each of the sunglasses and the eyeglasses. The sunglasses are then retained on the eyeglasses through magnetic attraction between the magnets. One of the issues with such systems comes from the nature of magnets themselves. Magnets all have a north pole, a south pole, and they exude a magnetic field. The sunglasses and eyeglasses will only be able to become engaged with one another if the magnets in the sunglasses and eyeglasses are oriented in a very specific fashion. The magnets have to be arranged so that their opposite poles are brought into close proximity to one another. In other words, the north pole of one magnet must be able to be brought into close proximity with the south pole of the other magnet. If, however, the magnets are arranged so that their like poles will be brought into close proximity to one another, then the eyeglasses and sunglasses will repel one another and will not be able to become engaged with one another. Correctly orienting the magnets in the eyeglasses and sunglasses is therefore critical.

### SUMMARY OF THE INVENTION

The present disclosure relates to an eyewear assembly which addresses some of the problems of prior art eyewear assemblies. An eyewear assembly including primary lenses in the form of eyeglasses, secondary lenses engageble with the eyeglasses, and a connector assembly. The secondary lenses may be sunglasses or any of a range of therapeutic lenses for concussion, migraine etc. that are a specified tint not used for sunglasses. Others secondary lenses could include a filter for blue light emitted by monitors or be clear, sunglass bifocals and readers for presbyopic people. The connector assembly includes a magnetic member and a non-magnetic member. The magnetic member is provided in one of the primary and secondary lenses, and the non-magnetic member is provided in the other of the primary and secondary lenses. The magnet attracts the non-magnetic member to itself when the secondary lenses are brought into close enough proximity to the primary lenses and thereby detachably retain the primary and secondary lenses in engagement with one another.

The non-magnetic member is fabricated preferably from a metal. In one embodiment, the non-magnetic member may be stainless steel. In another embodiment, the non-magnetic member may be a metal other than stainless steel. In a further embodiment, the non-magnetic member may be a coated metal. It will be understood that any suitable non-magnetic member may be used that will, with the magnetic member, hold the primary and secondary lenses in abutting contact with one another. Because the eyewear assembly uses only one magnet, the orientation of the magnet used in the one of the primary lenses and the secondary lenses is not critical. If the magnet presents a north pole or a south pole to the non-magnetic member, the non-magnetic member will still be coupled to the magnetic member and thus the secondary lenses will still be retained in engagement with the primary lenses. It is furthermore not critical if the magnet is installed in the primary lenses or the secondary lenses as either installation will function if the non-magnetic member is installed in the other of the primary lenses or the secondary lenses.

The magnetic member or non-magnetic member is received in a slot defined in a perimeter of the lenses of the eyeglasses and is retained therein by cooperative engagement of the eyeglass frame with the lens. The other of the magnetic member and the non-magnetic member is received in an aperture defined in the associated secondary lens. The aperture is created in a location which will align with the slot when the secondary lenses are brought into close proximity with the primary lenses. The magnet attracts the non-magnetic member to itself when the secondary lenses are brought into close enough proximity to the primary lenses and thereby detachably retains the primary and secondary lenses in engagement with one another.

The primary lenses as described herein may be referred to herein as “eyeglasses” and the secondary lenses as described herein may be referred to as “sunglasses”. It should, however, be understood that the two terms are not to be narrowly construed as eyeglasses with corrective or prescription lenses and sunglasses with lenses tinted to block Ultra Violet light. Rather, the terms should be understood as two lens types having different properties from one another that are contemplated as being useful to couple together to aid a person in some manner. In one embodiment, the eyeglasses include primary lenses which are prescription lenses and the secondary lenses are sunglasses but could be any one of a range of therapeutic lenses for concussion, migraine etc. that are a specified tint not used for sunglasses. Others secondary lenses could include a filter for blue light emitted by monitors, clear, sunglass bifocals and readers for presbyopic people.

In one aspect, an exemplary embodiment of the present disclosure may provide an eyewear assembly comprising primary lenses, secondary lenses, and a connector assembly detachably securing the primary lenses and the secondary lenses to one another; wherein the connector assembly comprises a magnetic member provided in a lens of one of the primary lenses and the secondary lenses; and a non-magnetic member provided in a lens of the other of the primary lenses and the secondary lenses.

In one embodiment, the non-magnetic member may be comprised of a material which is attractable to the magnetic member. In one embodiment, the material may be a metal. In one embodiment, the metal may be stainless steel. In one embodiment, a region of the magnetic member may extend outwardly beyond a surface of an associated lens of the one of the primary lenses and the secondary lenses. In one embodiment, a region of the non-magnetic member may extend outwardly beyond a surface of an associated lens of the other of the primary lenses and the secondary lenses. In one embodiment, an end surface of the magnetic member in the one of the primary lenses and the secondary lenses may contact an end surface of the non-magnetic member in the other of the primary lenses and the secondary lenses when the secondary lenses are operatively engaged with the primary lenses. In one embodiment, the eyewear assembly may further comprise a space defined between an outer surface of the lens of the primary lenses and an inner surface of the lens of the secondary lenses.

In one embodiment, a notch may originate in a peripheral edge of the lens of the primary lenses and the one of the magnetic member and the non-magnetic member is received in the notch. In one embodiment, the notch may extend between an outer surface and an inner surface of the lens of the primary lenses. In one embodiment, a region of a wall of the lens which defines the notch may be complementary in configuration to a portion of a circumferential surface of the one of the magnetic member and the non-magnetic member received in the notch. In one embodiment, the eyeglass assembly may further comprise a securement mechanism provided on the primary lenses, wherein the securement mechanism retains the one of the magnetic member and the non-magnetic member in the notch. In one embodiment, the securement mechanism may comprise a portion of a frame of the primary lenses. In one embodiment, the securement mechanism may comprise a length of a nylon wire provided on the primary lenses. In one embodiment, an aperture may extend between an outer surface and an inner surface of the lens of the secondary lenses, wherein the aperture is located a distance inwardly away from a peripheral edge of the lens of the secondary lenses, and wherein the other of the magnetic member and the non-magnetic member is received in the aperture.

In one aspect, an exemplary embodiment of the present disclosure may provide a method comprising providing primary lenses including at least one eyeglass lens; providing secondary lenses including at least one sunglass lens; providing a magnetic member; providing a non-magnetic member; installing one of the magnetic member and the non-magnetic member on the at least one eyeglass lens; installing the other of the magnetic member and the non-magnetic member on the at least one sunglass lens; attracting the non-magnetic member to the magnetic member; and retaining the secondary lenses to the primary lenses.

In one embodiment, the method further comprises defining a notch in the at least one eyeglass lens; defining an aperture in the at least one sunglass lens; installing he one of the magnetic member and the non-magnetic member in the notch defined in the at least one eyeglass lens; and installing the other of the magnetic member and the non-magnetic member in the aperture defined in the at least one sunglass lens. In one embodiment, the method may further comprise moving the secondary lenses and primary lenses into close proximity with one another and aligning the magnetic member in the one of the primary lenses and the secondary lenses with the non-magnetic member in the other of the primary lenses and the secondary lenses. In one embodiment, the method may further comprise bringing the magnetic member and the non-magnetic member into direct contact with one another. In one embodiment, providing the non-magnetic member may include providing a rod of stainless steel capable of being attracted to a magnet.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a front, top, right side perspective view of a first embodiment of eyeglasses in accordance with an aspect of the present disclosure;

FIG. 2A is a partially exploded front, top, right side perspective view of the eyeglasses of FIG. 1;

FIG. 2B is a partially exploded front, top, right side perspective view of a pair of lenses for the eyeglasses, shown in isolation;

FIG. 3 is a front elevation view of the eyeglasses shown in isolation;

FIG. 4A is a cross-section of a region of the eyeglasses taken along line 4A-4A of FIG. 3;

FIG. 4B is a cross-section of a region of the eyeglasses taken along line 4B-4B of FIG. 3;

FIG. 5 is an enlarged, exploded front elevation view of a first embodiment of a single lens of the eyeglasses shown in FIG. 3;

FIG. 5A is a partial enlarged, exploded front elevation view of a second embodiment of a single lens of the eyeglasses shown in FIG. 3;

FIG. 5B is a partial enlarged, exploded front elevation view of a third embodiment of a single lens of the eyeglasses shown in FIG. 3;

FIG. 5C is a partial enlarged, exploded front elevation view of a fourth embodiment of a single lens of the eyeglasses shown in FIG. 3;

FIG. 6 is a front, top, right side elevation view of the eyeglasses of FIG. 3 showing a first embodiment of sunglasses in accordance with an aspect of the present disclosure exploded outwardly away therefrom;

FIG. 7 is a front, top, right side elevation view of the eyeglasses of FIG. 3 showing the first embodiment of the sunglasses of FIG. 6 operatively engaged therewith;

FIG. 8A is a cross-section of the eyeglasses and the first embodiment sunglasses taken along line 8A-8A of FIG. 6;

FIG. 8B is a cross-section of the eyeglasses and the first embodiment sunglasses taken along line 8B-8B of FIG. 7;

FIG. 9 is a front, top, right side elevation view of the eyeglasses of FIG. 3 showing a second embodiment of sunglasses in accordance with an aspect of the present disclosure exploded outwardly away therefrom;

FIG. 10 is a cross-section of the eyeglasses and the first embodiment sunglasses similar to FIG. 8B except showing the steel rod located in the eyeglasses and the magnet located in the first embodiment sunglasses;

FIG. 11 is a front elevation view of a second embodiment of eyeglasses in accordance with an aspect of the present disclosure;

FIG. 11A is a cross-section through a lens of the eyeglasses taken along line 11A-11A of FIG. 11; and

FIG. 11B is a cross-section through a lens of the eyeglasses taken along line 11B-11B of FIG. 11.

Similar numbers refer to similar parts throughout the drawings.

### DETAILED DESCRIPTION

The present description relates to an eyewear assembly comprising primary lenses, secondary lenses, and a connector assembly for operably detachably engaging the primary lenses and secondary lenses to one another. For ease of description, the primary lenses will be referred to herein as “eyeglasses” and the secondary lenses will be referred to herein as “sunglasses”. It will be understood that any suitable types of lenses for improving or enhancing the vision of a user are contemplated to be usable as either of the primary lenses or the secondary lenses.

As will be described hereafter, the sunglasses are retained in operable engagement with the eyeglasses utilizing the connector assembly. The connector assembly includes at least one magnet provided in each lens of the eyeglasses or the sunglasses, and a non-magnet provided in each lens of the other of the eyeglasses and the sunglasses. The non-magnet may be in the form of a rod fabricated from a metal that is able to be attracted to a magnet. The attraction between the magnet(s) and non-magnet(s) holds the primary lenses and secondary lenses adjacent one another. These various components and how they interact with one another will be described hereafter. It will be understood that the magnet(s) may be provided on the eyeglasses or the sunglasses and that the non-magnetic rods will then be provided on the other of the eyeglasses and the sunglasses. The following describes an embodiment where the magnets are provided on the eyeglasses and the non-magnetic rods are provided on the sunglasses.

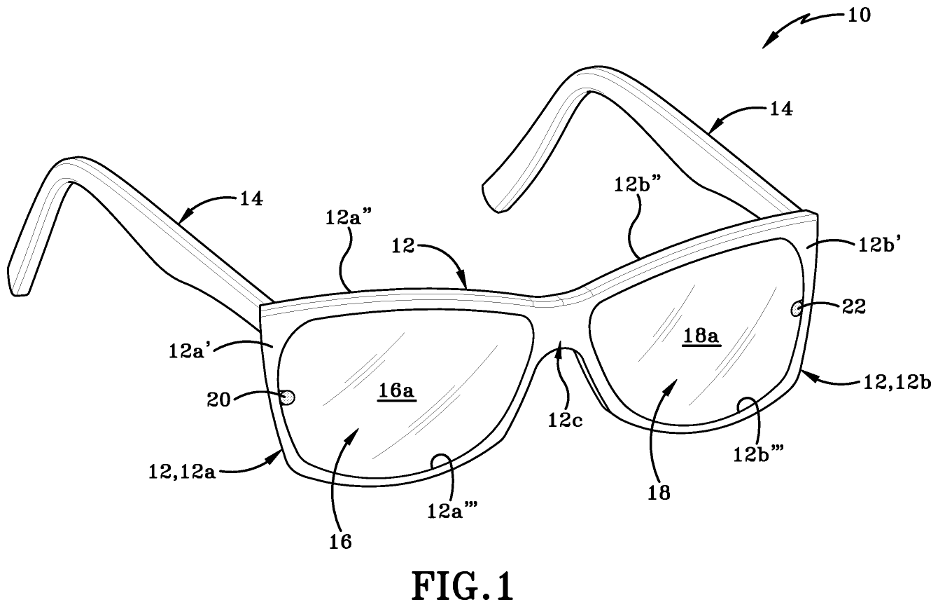

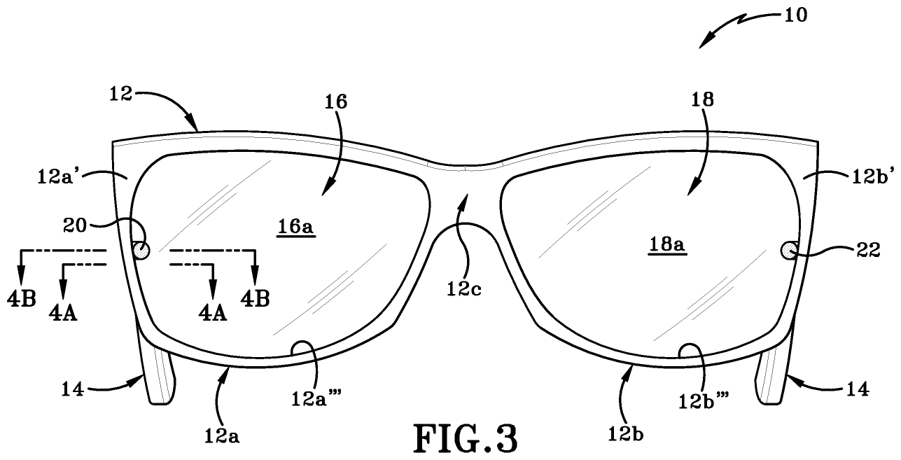

Referring to FIGS. 1-5, there is shown a first embodiment of eyeglasses in accordance with an aspect of the present disclosure, generally indicated at 10. Eyeglasses 10 comprise a frame 12, a pair of arms 14 which are pivotally engaged with opposite sides of the frame 12, a first lens 16, and a second lens 18. First lens 16 and second lens 18 may be prescription lenses.

Frame 12 comprises a first region 12a having a front surface 12a′, a rear surface 12a″, and the first region 12a defines a first aperture 12a″ therein. Similarly, frame 12 includes a second region 12b which has a front surface 12b′ and a rear surface (not shown), and the second region 12b defines a second aperture 12b″ therein. A bridge 12c extends between first region 12a and second region 12b. When eyeglasses 10 are worn, bridge 12c will rest upon a person's nose and the two arms 14 will extend along opposing sides of the person's head and rest on a top of an associated ear. It will be understood that the configuration of frame 12 illustrated in the attached figures is exemplary only and that any desired configuration of frame 12 may be utilized in the performance of the disclosed eyewear assembly and method.

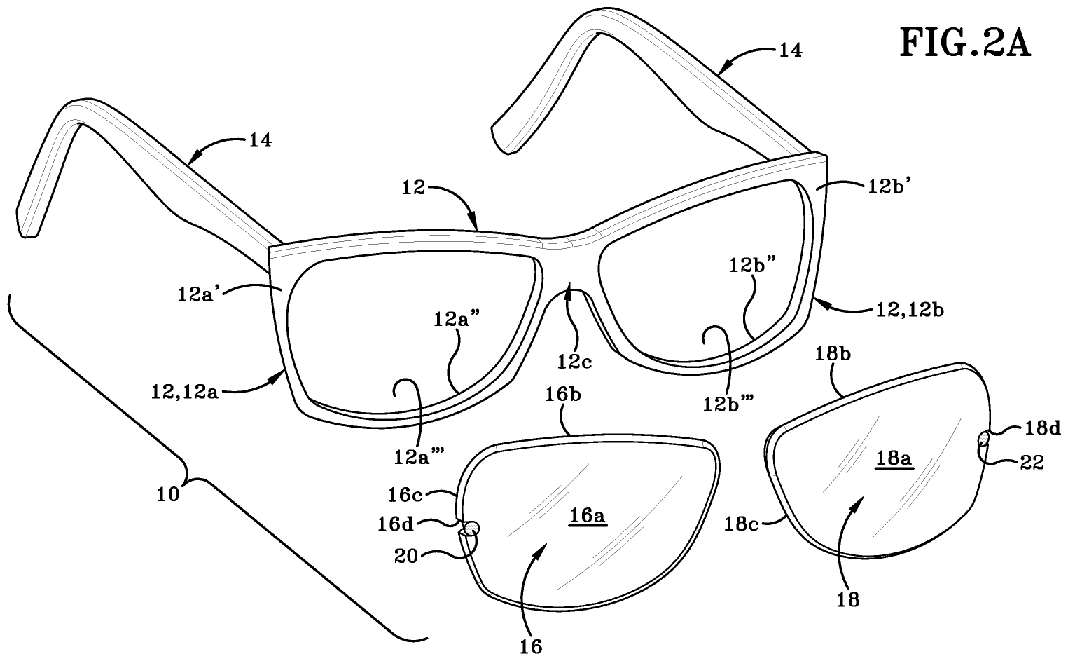

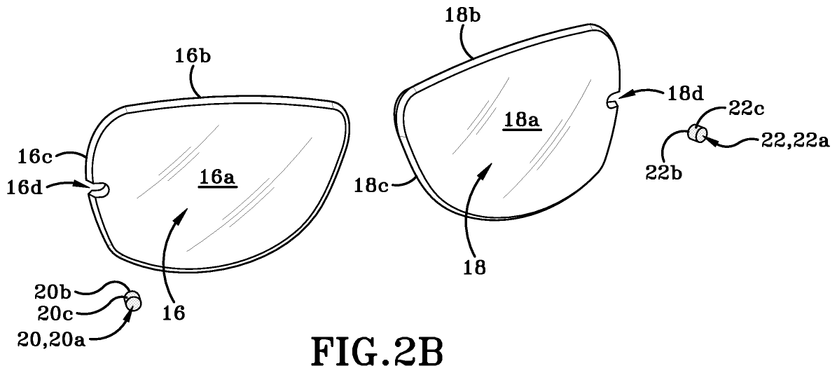

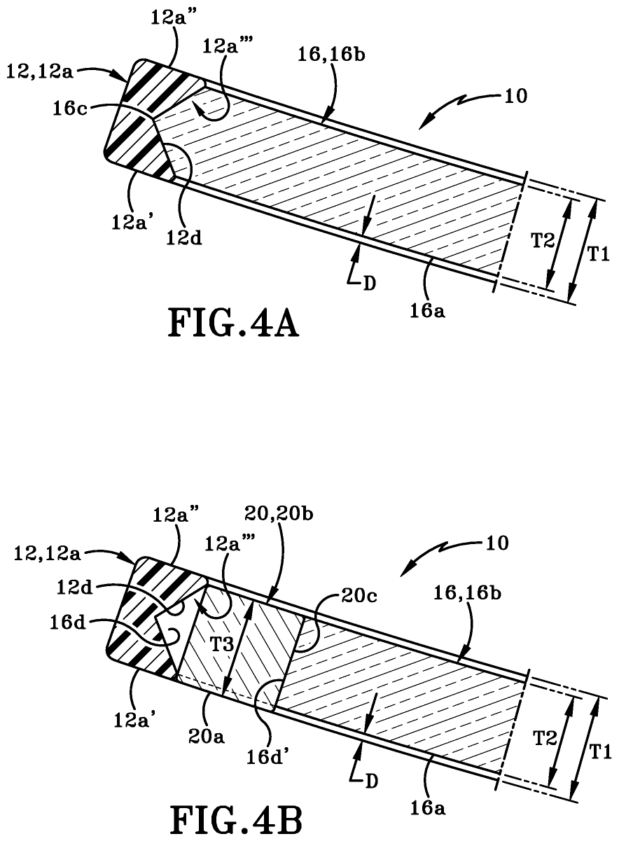

First lens 16 and second lens 18 are each configured so as to be complementary to the shape and size of the respective first aperture 12a″ and second aperture 12b″′ defined by frame 12. In accordance with a specific aspect of the present disclosure and as best seen in FIGS. 2B-4B, each of the first lens 16 and second lens 18 18 has an outer surface 16a, 18a and an inner surface 16b, 18b (FIGS. 2 and 4A). A beveled peripheral edge 16c (FIG. 2A) extends between outer surface 16a and inner surface 16b of the first lens 16. Similarly, a peripheral edge 18c (FIG. 2A) extends between outer surface 18a and inner surface 18b of second lens 18.

As best seen in FIG. 4A, the peripheral edge 16c (and similarly the peripheral edge 18c) is configured to be complementary in profile to the wall of frame 12 which defines first aperture 12a″ (and similarly second aperture 12b″). FIG. 4A shows that the wall of first region 12a of frame 12 which defines first aperture 12a″ is configured to define a V-shaped depression 12d therein. The wall defining the V-shaped depression 12d therein circumscribes the first aperture 12a″. The wall of frame 12 which defines second aperture 12b″ is similarly configured. The profiles of the peripheral edges 16c, 18c of the first lens 16 and second lens 18 are complementary to the profiles of the walls defining first aperture 12a″′ and second aperture 12b″. When first lens 16 is received within first aperture 12a″′ of frame 12, the V-shaped profile of the beveled peripheral edge 16c of first lens 16 is received in the complementary V-shaped depression 12d defined in the wall which circumscribes first aperture 12a″. This complementary matching configuration helps retain first lens 16 in engagement with frame 12. Second lens 18 is similarly retained in engagement with frame 12.

It will be understood that frame 12 may define any shape and size opening 12a, 12b therein and that the wall of frame 12 which defines those openings 12a, 12b may have any profile that is desired in order to keep first lens 16 and second lens 18 engaged therewith. The profile of the wall defining the apertures 12a″′, 12b″ may therefore be formed with a depression having a different configuration than the V-shape illustrated in the attached drawings. For example, the depression formed in the wall bounding the apertures 12a″, 12b″ may be square, or U-shaped. The peripheral edge 16c, 18c of the first and second lenses 16, 18 will then be a complementary square-shape or U-shaped. Alternatively, the depression may be formed on the peripheral edge 16c, 18c and a complementary projection may be provided on the wall which bounds and defines the apertures 12a″′, 12b″. The first and second lenses 16, 18, for example, may be formed with a V-shaped, square, or U-shaped depression in their peripheral edges 16c, 18c and the wall of frame 12 which defines the respective apertures 12a″′, 12b″ may be formed with a projection which fits complementarily into the depression defined in the lenses 16, 18.

In accordance with an aspect of the present disclosure, a notch 16d (FIG. 2B) is formed in the peripheral edge 16c of first lens 16 and extends for a distance inwardly into the body of the first lens 16. notch 16d extends between outer surface 16a and inner surface 16b of first lens 16. notch 16d preferably is formed on a section of peripheral edge 16c of first lens 16 which will be engaged with a side of the first region 12a of frame 12 that is located remote from bridge 12c. Similarly, a notch 18d is formed in the peripheral edge 18c of second lens 18 and extends for a distance inwardly into the body of the second lens 18. notch 18d extends between outer surface 18a and inner surface 18b of second lens 18. notch 18d preferably is formed on a section of peripheral edge 18c of second lens 18 which will be engaged with a side of the second region 12b of frame 12 remote from bridge 12c. Preferably, first notch 16d and second notch 18d are laterally aligned with one another so that the eyeglasses have a symmetrical in appearance relative a vertical axis passing through the bridge 12c. This symmetrical arrangement will give eyeglasses 10 a more aesthetically pleasing appearance.

It will be understood that in other embodiments, notches 16d, 18d may be formed at any other desired location on the peripheral edge 16c, 18d of the associated one of first lens 16 and second lens 18. It will further be understood that more than one notch 16d, 18d may be formed on the respective peripheral edge 16c, 18d of the associated one of first lens 16 and second lens 18. If more than one notch 16d, 18d is defined in the associated lenses 16, 18, it will be understood that any notch(s) may be defined in the side of the peripheral edge 16c, 18c remote from bridge 12c and/or proximate bridge 12c, and/or either along a top edge and/or bottom edge of lenses 16, 18. It will be further understood that in other embodiments, the location of the notch(s) 16d in first lens 16 may not be mirrored in the location of notch 18d in second lens 18. In other words, first lens 16 and second lens 18 may not be symmetrical relative to a vertical axis passing through bridge 12c.

As best seen in FIG. 2B, in the first embodiment eyeglasses 10, each notch 16d, 18d is generally U-shaped when first lens 16 and second lens 18 are viewed from a direction looking at the outer surfaces 16a, 18a thereof. The U-shape originates in the peripheral edge 16c, 18c and extends for a distance inwardly into the body of the associated lens 16, 18. The curved surface of the U-shape is located a distance inwardly away from the peripheral edge 16c, 16d.

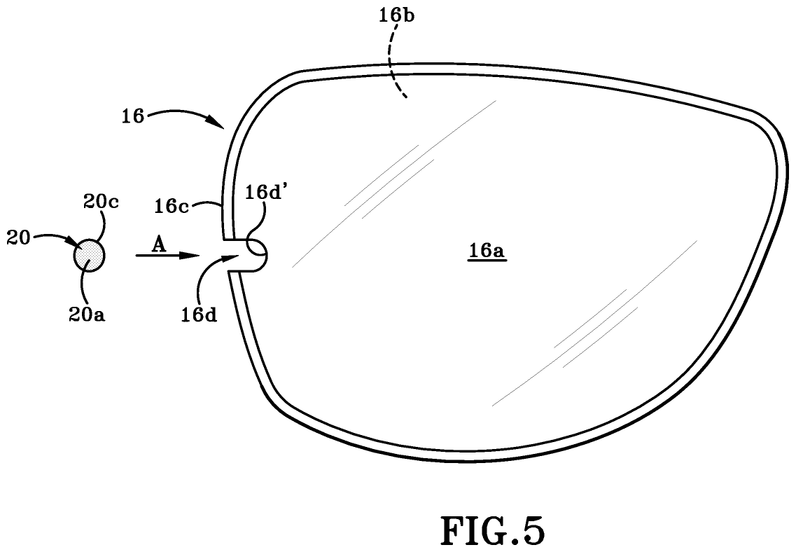

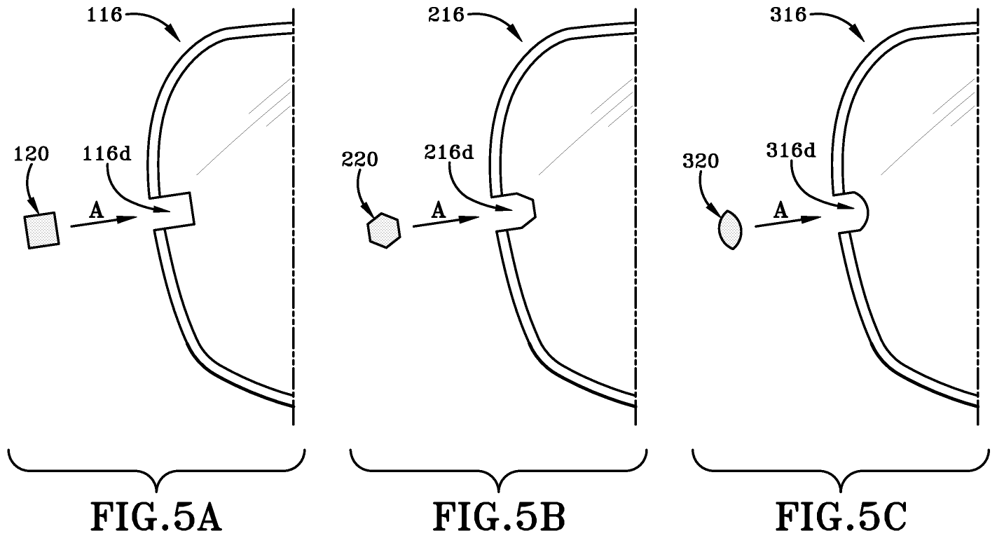

It will be understood that the U-shape of the notches 16d, 18d is only exemplary of one of many suitable shapes in which the notches may be formed. In other embodiments, the shape of each notch 16d, 18d may be other than U-shaped. A small sample of other exemplary shaped notches are illustrated in FIGS. 5A, 5B, and 5C. FIG. 5A, for example, shows a second embodiment lens 116 defining a square-shaped notch 116d therein. FIG. 5B shows a third embodiment lens 216 defining a U-shaped notch 216d wherein the innermost edge of the notch is comprised of three-straight sections instead of a curve. FIG. 5C shows a fourth embodiment lens 316 defining an U-shaped notch 316d which is wider than notch 16d and is tending to be generally elliptical in nature. Although not illustrated herein, it will be understood that the notches may, alternatively, be keyhole shaped, triangular, rectangular, or even irregular in shape. It will be understood that any desired shape of notch may be formed in first lens 16 and second lens.

In accordance with one aspect of the present disclosure a first magnet 20 is received in the notch 16d of first lens 16 and a second magnet 22 is received in the notch 18d of second lens 18. Magnets 20, 22 are shaped and sized such that they are received in the associated notches 16d, 18d and are retained therein by a portion of the frame 12 of eyeglasses 10. The portion of the frame 12 acts as a securement mechanism which keeps the magnet 20 or magnet 22 within the associated lens 16, 18. If the frame 12 and one or both lenses 16, 18 are disengaged from one another, the associated magnet 20 or magnet 22 will tend to fall out or drop out of the associated notch 16d, 18d. FIG. 2B shows that each of the first and second magnets 20, 22 is generally cylindrical in shape. Utilizing a generally U-shaped notch 16d, 18d and cylindrical magnet with a circular cross section tends to reduce stress in the lenses 16, 18 but any configuration notch and complementary cross-section of magnet is contemplated for the disclosed eyewear assembly and method.

FIGS. 2B and 4B show that first magnet 20 has a first surface 20a and an opposed second surface 20b with a circumferential wall 20c extending between first surface 20a and second surface 20b. Similarly, second magnet 22 has a first surface 22a and an opposed second surface 22b with a circumferential wall 22c extending b3etween first surface 22a and second surface 22b. Circumferential walls 20c, 22c have a radius of curvature which is complementary to the curved innermost edge of the associated notch 16d, 18d. FIG. 5, for example, shows the curved innermost edge 16d′ of the wall of lens 16 which defines notch 16d. The wall of second lens 18 which defines notch 18d will have a substantially similar curved innermost edge having a radius of curvature which is complementary to the radius of curvature of the circumferential wall 22c of second magnet 22.

In order to install first magnet 20 within notch 16d, first magnet 20 is slid into the opening to notch 16d in the direction indicated by arrow “A” in FIG. 5. The diameter of first magnet 20 is such that the magnet may be at least partially retained within notch 16d by friction. When the lenses 16, 18 are installed within frame 12, as described later herein, the frame 12 keeps each magnet 20, 22 retained in the associated lens 16, 18.

It should be noted that while every magnet 20, 22 has a north pole and a south pole, the orientation of the poles in the installation of the magnets 20, 22 is completely irrelevant since the components which are to interact with the magnets 20, 22 in the present disclosure are not, themselves, magnetic but are instead non-magnetic.

FIGS. 5A, 5B and 5C show different configurations of first magnets, namely magnets 120, 220, and 320 being inserted into substantially complementary notches 116d, 216d, and 316d in the second, third, and fourth embodiments of first lenses 116, 216, and 316, respectively. The magnets 120, 220, 320 can be slid into an out of the associated notches 116d, 216d, 316d as indicated by the arrows “A”. The notch 116d in lens 116 is substantially square in configuration and the first magnet 120 which is receivable in notch 116d is substantially square in configuration. The notch 216d in lens 216 is substantially U-shaped with an innermost edge of the wall defining the notch 216d having three straight sections of substantially equal length. The first magnet 220 which is receivable in notch 216d is substantially hexagonal in configuration. When first magnet 220 is received in notch 216d three of the six faces nesting with the innermost edge of the wall defining notch 216d. The notch 316d in lens 316 is a wide U-shaped notch and the magnet 320 that is configured to be received in the notch 316d is generally elliptical in shape. The magnet 320 has a curved side edge which will nest with the innermost edge of the wall defining the notch 316d when magnet 320 is received therein.

FIG. 4A shows the first magnet 20 of the first embodiment eyeglasses 10 received within the notch 16d defined by first lens 16. As is evident FIG. 4A, first region 12a (and second region 12b) of frame 12 is of a thickness “T1” measured between the front surface 12a′ and rear surface 12a″ thereof. First lens 16 is of a thickness “T2” measured from outer surface 16a to inner surface 16b thereof. The thickness “T1” is greater than the thickness “T2”. FIG. 4B shows that first magnet 20 is of a thickness “T3” as measured from first surface 20a to second surface 20b thereof. The thickness “T3” is greater than the thickness “T2” and may be equal to or greater than the thickness “T1”. In other words, magnet 20 (and magnet 22) is of a greater thickness than the first lens 16 (and second lens 18) and may be of a thickness that is equal to or greater than that of the frame 12. The second surface 20b of magnet 20 is substantially flush with the inner surface 16b of lens 16 and the first surface 20a of magnet 20 projects a distance “D” outwardly beyond the outer surface 16a of lens 16. In some embodiments, the first surface 20a of magnet 20 is flush with the front surface 12a′ of first region 12a of frame 12. In some embodiments, the first surface 20a of first magnet 20 will project for a distance outwardly beyond the front surface 12a′ of first region 12a of frame 12 and may therefore project for a distance greater than “D” outwardly beyond outer surface 16a of lens 16. The distance “D” is about 1 mm in one embodiment of eyeglasses 10. Sometimes, if lenses 16, 18 are thicker than the frame 12, the position of the outer surface 16a, 18a of the respective lens 16, 18 is a more critical determinant of the overall length of the magnet 20, 22. In order to keep the sunglass lenses away from the outer surface 16a, 18a of eyeglasses 10, as will be described later herein, both the magnets 20, 22 and metal rods associated with the sunglasses need to protrude outwardly from the associated lenses to ensure that the surfaces of the lenses of the eyeglasses 10 and those of the sunglasses do not contact one another. If one lens surface is touching another, the lenses may develop abrasions if dust or other particulates are present between the lens surfaces.

The thickness “T3” of the magnet 20, 22 is greater than the thickness of the frame 12 may be longer than the thickness of the frame 12 such that the magnets 20, 22 protrude past the outer surface 16a, 18a of the eyeglass lenses 16, 18 by about 1 mm. Alternatively, the thickness of the magnet 20, 22 should be such that the first end 20a, 20a of the magnet 20, 22 is flush with the outermost surface 12a″ of the frame 12.

It will be understood that since first and second magnets 20, 22 are cylindrical in shape and therefore have a circular circumferential exterior surface while notches 16d, 18d are U-shaped, the magnets 20, 22 are not precisely complementary in shape to the notches 16d, 18d. Only the circumferential surface 20c, 22c of first and second magnets 20, 22 with the same radius of curvature as the arcuate innermost edge (16d′ for example) of the associate lens 16, 18 is complementary to the notch 16d, 18d.

The rest of the wall of the first lens 16 and second lens 18 which define the respective notch 16d, 18d is not complementary to the rest of the circumferential surface 20c, 22c of magnets 20, 22. As a consequence, only portions of the first and second magnets 20, 22 are in direct abutting contact with the wall which defines the notches 16d, 18d in lenses 16, 18.

Frame 12 holds lenses 16, 18 in place. The interlocking of the frame 12 and lenses 16, 18 holds the magnets 20, 22 in place. There are many different metal or plastic frame designs that will hold a lens in place. Complete rimless designs of eyeglasses will not be able to be used in the performance of the disclosed method. Almost all frames have sufficient flexibility to accommodate and hold lenses 16, 18 without damaging them. Lenses 16, 18 have to be edged to the correct size so as not to be too loose within the frame 12 or they will fall out of the frame 12 and may break or be damaged. The lenses 16, 18 cannot be too large for the frame as this may cause deformation of the frame and/or breakage of the frame and/or lenses 16, 18. With the lenses 16, 18 interlocked within frame 12, there is an equilibrium between the two. In order to install the magnets 20, 22, after the respective lens 16, 18 has been edged to the correct size, the notch 16d, 18d is filed into or cut into the lens 16, 18 to the appropriate depth. In a next step, the magnet 20, 22 is inserted into the notch 16d, 18d and the lens 16 or 18 is then compressed into the frame 12 if the frame is an acetate frame. If the frame 12 is a metal frame, the eye wire will be held in place until the set screw is secured. The diameter of each magnet 20, 22 is such that the magnets 20, 22 may be retained partially within the associated notch 16d, 18d by friction exerted by the respective lens 16, 18 and partially by a portion of the frame 12 which closes off access to the opening to the notch 16d, 18d. In other instances, the magnets 20, 22 are entirely retained within notches 16d, 18d and thereby within lenses 16, 18 by the frame 12 pinching or squeezing the lens 16, 18. In other words, the magnets 20, 22 are held in place in the associated lens 16, 18 by the pressure or pinch of the frame 12 and lens 16, 18 together. This capturing of the magnet 20 within notch 16d is illustrated in FIG. 4B. Small regions of the frame 12 which close off access to the opening to the notch 16d may also assist in retaining the magnet 20 within the lens 16 and within notch 16d thereof. The same arrangement is true of second magnet 22, notch 18d, lens 18 and frame 12. Magnets 20, 22 are essentially “pinched” or “squeezed” between the frame 12 and the associated lens 16, 18. At least part of the exterior circumferential surface 20c, 22c of each respective magnet 20, 22 is not surrounded by material of the associated lens 16, 18.

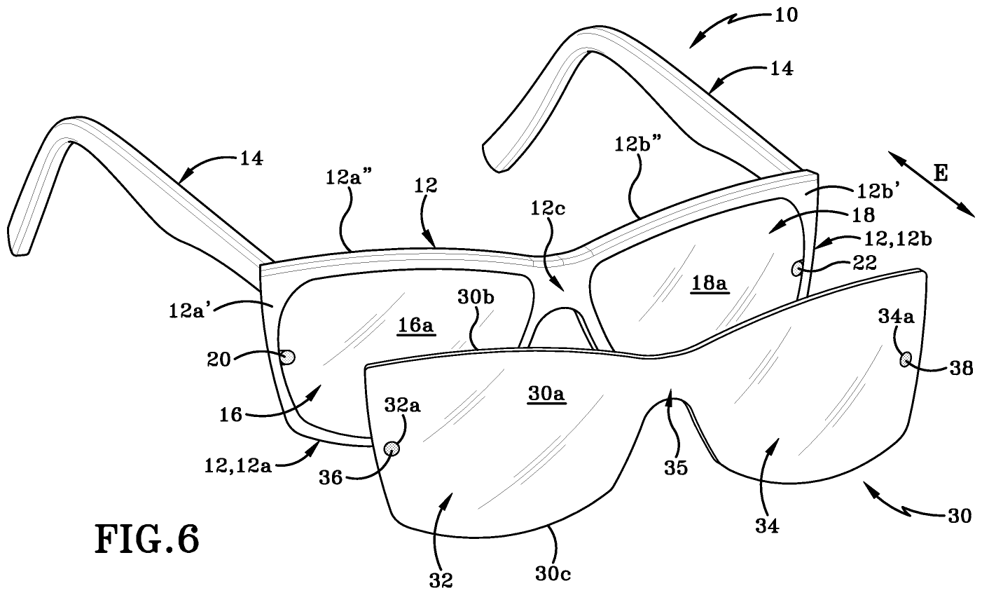

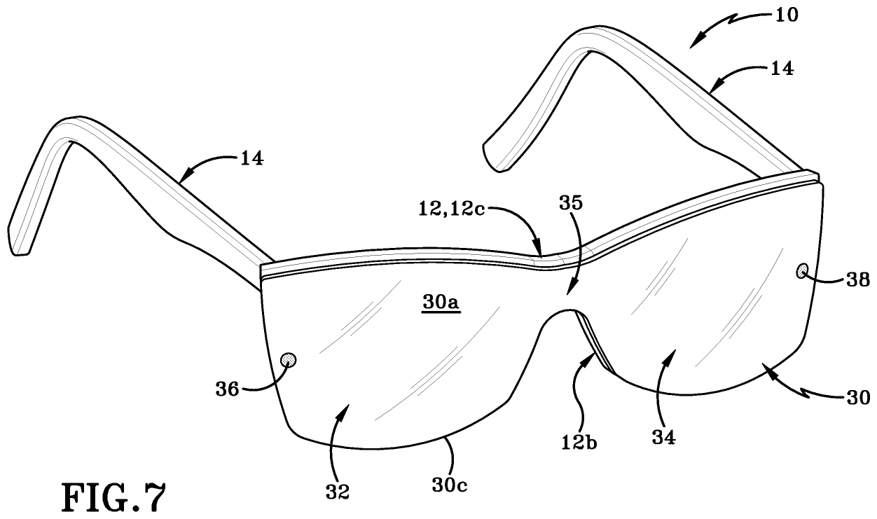

Referring now to FIGS. 6 through 8B, there is shown the first embodiment eyeglasses 10 described above along with a first embodiment of sunglasses in accordance with an aspect of the present disclosure. The sunglasses are generally indicated by the reference number 30. The sunglasses 30, as illustrated, comprise a single continuous sheet of lens material which is fabricated to form a first lens 32 and a second lens 34 of the sunglasses 30. As disclosed earlier herein, secondary lenses may be sunglass lenses or any one of a range of therapeutic lenses for concussion, migraine etc. that are a specified tint not used for sunglasses. Others secondary lenses could include a filter for blue light emitted by monitors, clear, sunglass bifocals and readers for presbyopic people.

A bridge region 36 connects the first lens 32 and second lens 34 to one another. The sunglasses 30 have an outer surface 30a and an inner surface 30b and a perimeter edge 30c which extends between the outer surface 30a and inner surface 30b. The overall configuration of the first lens 32 and second lens 34 is generally similar to the overall exterior shape of frame 12 with first lens 16 and second lens 18 therein. Sunglasses 30 are configured to be operatively engaged with eyeglasses 10 as indicated by arrow “E” in FIG. 6. The manner of operatively engaging sunglasses 30 with eyeglasses 10 will be described later herein.

In accordance with an aspect of the present disclosure, a first aperture 32a is defined in first lens 32 and a second aperture 34a is defined in second lens. The apertures 32a, 34a extend between the outer surface 30a of the associated lens 32, 34 and the inner surface 30b thereof. Each aperture 32a, 32b is located a distance inwardly away from the perimeter edge 30c of sunglasses 30. In particular, apertures 32a, 32b are located so as to selectively alignable with the magnets 20, 22 of eyeglasses 10 when sunglasses 30 are operatively engaged with eyeglasses 10.

In accordance with a further aspect of the present disclosure, a first rod 36 and a second rod 38 are operatively engaged in first aperture 32a and second aperture 34a respectively. Rods 36, 38 are fabricated from metals or metal alloys and can be of any suitable cross section and shape. Even custom shapes can be fabricated to provide a more aesthetically appealing and interesting appearance to sunglasses 30. Each of the first rod 36 and second rod 38 is tightly retained within the associated first aperture 32a and second aperture 34a in any suitable manner. Suitable manners of retaining the rods 36, 38 in place include but are not limited to press-fitting the rods 36, 38 into the sunglasses' lens material and retaining the same therein through friction. Adhesives are not utilized to hold the rods 36, 38 in place. It will be understood, however, that in other embodiments, adhesives or other fastening mechanisms may be utilized instead of press-fitting.

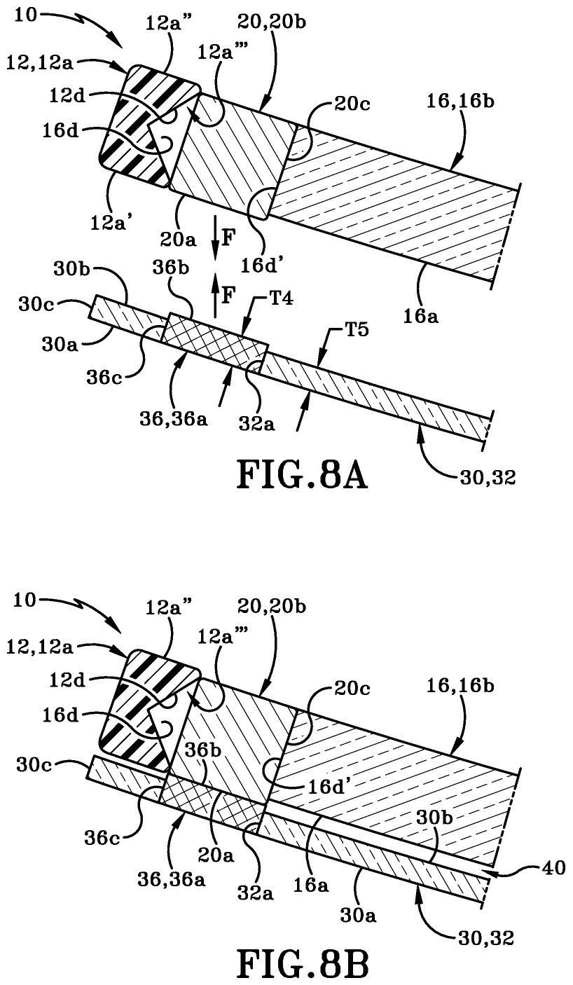

As best seen in FIG. 8A, first rod 36 includes a first end 36a, a second end 36b opposed to first end 36a, and a perimeter surface 36c extending between first end 36a and second end 36b. The thickness of first rod 36 is indicated as thickness “T4” as measured between first end 36a and second end 36b. The thickness of the sunglasses' lens material is indicated as thickness “T5”. As is evident from FIG. 8A, thickness “T4” of first rod 36 is greater than thickness “T5” of the sunglasses' lens material. First rod 36 is arranged in the lens material of sunglasses 30 in such a way that a portion of the first rod 36 extends outwardly for a distance beyond the inner surface 30b of the lens 32. First rod 36 is arranged such that first end 36a thereof is substantially flush with outer surface 30a of the lens 32 of sunglasses 30. It will be understood that second rod 38 is similarly arranged in sunglasses 30.

In the first embodiment sunglasses 30, the configuration of first rod 36 and second rod 38 is substantially similar to the configuration of the magnets 20, 22 in eyeglasses 10. As illustrated, each of the magnets 20, 22 is generally cylindrical in configuration and presents a generally circular first end 20a, 22a which is located a distance outwardly beyond an outer surface of the associated first lens 16 and second lens 18, respectively, of eyeglasses 10. Similarly, each of the first and second rods 36, 38 is generally cylindrical and presents a generally circular second end (such as second end 36b) which is located a distance outwardly beyond an inner surface 30b of sunglasses 30. As illustrated in FIGS. 8A and 8B, in some embodiments, the diameter of the first and second magnets 20, 22 and the diameter of the first and second rods 36, 38 is substantially the same. It will be understood, however, that in other embodiments, the diameter of the first and second magnets 20, 22 may be greater than or smaller than the diameter of the first and second rods 36, 38.

In accordance with an aspect of the present disclosure, each of the first rod 36 and the second rod 38 is comprised of a non-magnetic material. In particular, each of the first rod 36 and second rod 38 is comprised of a metal and, more particularly, from a non-magnetic metal. In other words, the metal first and second rods 36, 38 utilized in sunglasses 30 do not have a north pole or a south pole, nor do they exhibit a magnetic field in of themselves. One suitable metal for first rod 36 and second rod 38 is steel. In one embodiment, the steel is stainless steel. Specifically, the stainless steel is of a type that is capable of being attracted to a magnet. The metal used for first rod 36 and second rod 38 is not, in of itself, magnetic. In other words, the metal is incapable of magnetically attracting other metals towards itself. The metal used in rods 36, 38 may be of a type, however, that is able to be attracted to a magnet.

Sunglasses 30 are operatively engaged with eyeglasses 10 by moving sunglasses 30 towards eyeglasses 10 or vice versa as indicated by arrow “E” in FIG. 6. The movement “E” towards one another is continued until first and second rods 36, 38 are aligned with first and second magnets 20, 22 and are brought into abutting physical contact with one another. When first and second rods 36, 38 are either close enough to first and second magnets 20, 22 or are in physical contact with the same, the magnetic fields of first and second magnets 20, 22 attracts the non-magnetic material of first and second rods 36, 38 thereto. T Sunglasses 30 are thus retained in operative engagement with eyeglasses 10.

As is evident from FIG. 8B, when sunglasses 30 are operatively engaged with eyeglasses 10 via magnets 20, 22 and rods 36, 38, a space 40 is defined between the outer surface 16a of first lens 16 (and the outer surface 18a of second lens 18) and the inner surface 30b of sunglasses 30. The space 40 is of a size that is of a size equal to a thickness of the portions of magnets 20, 22 which extend beyond the outer surfaces 16a, 18a of the associated lenses 16, 18 plus the thickness of the portions of the rods 36, 38 which extend beyond the inner surface 30b of sunglasses 30. When it is desired to remove sunglasses 30 from eyeglasses 10, sunglasses 30 are simply pulled away from eyeglasses 10 and the attraction between first and second magnets 20, 22 and first and second rods 36, 38 is broken. The space 40 ensures that the sunglasses 30 are not brought into physical contact with the outer surfaces 16a, 18a of the lenses 16, 18 and thus reduces the possibility that the sunglasses 30 might inadvertently scratch or otherwise damage the lenses 16, 18.

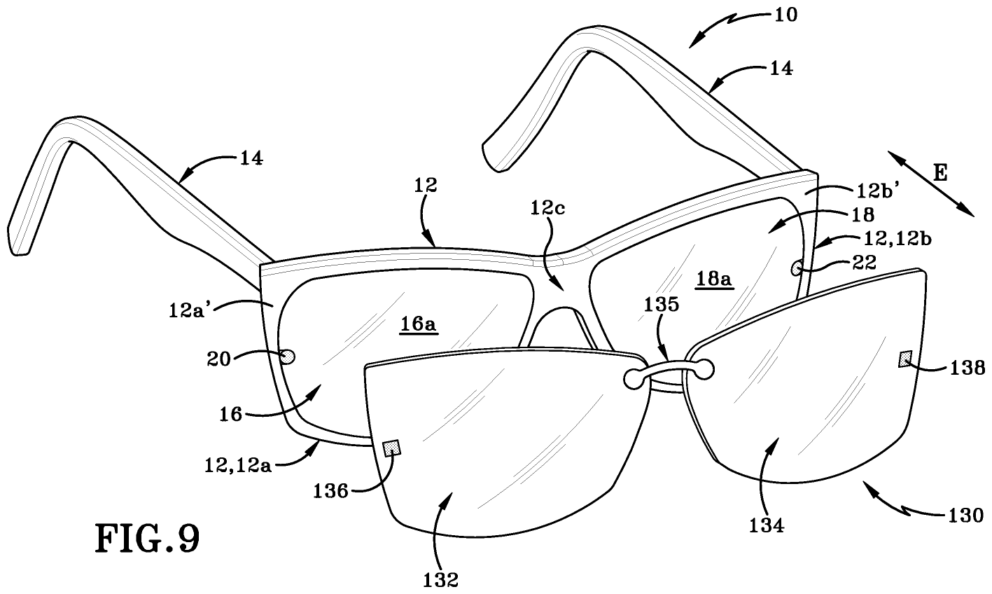

FIG. 9 shows a second embodiment of sunglasses 130 which are operatively engageable, as indicated by arrow “E”, with eyeglasses 10. Sunglasses 130 differ in configuration from sunglasses 30 in that the sunglasses 130 comprise two separate lenses 132, 134 which are connected to one another by a bridge 136. It will be understood that lenses 132, 134 may be prescription lenses. Each of the first lens 132 and second lens 134 is provided with a first rod 136 and a second rod 138, respectively. First rod 136 and second rod 138 are substantially identical in all respects to first rod 36 and second rod 38 except for the overall shape and size thereof. While first rod 36 and second rod 38 are cylindrical in configuration and present a circular second end for physical contact with the circular first ends 20a, 22a of magnets 20, 22, first and second rods 136, 138 are cuboid in configuration and present a square second end for physical contact with the circular first ends 20a, 22a of magnets 20, 22. Otherwise, sunglasses 130 are operatively engageable and disengageable with eyeglasses 10 in substantially an identical manner to sunglasses 30. It will be understood that the configuration of magnets 20, 22 and rods 136, 138 may be reversed, i.e., magnets 20, 22 may be cuboid in configuration while rods 136, 138 may be cylindrical in configuration. It will further be understood that magnets 20, 22, and rods 136, 138 (or 36, 38) may be of any desired configurations, and may be similar or dissimilar to one another. All that is needful is that the magnets 20, 22 and rods 136, 138 (or 36, 38) present a sufficient degree of alignable surface area to one another to enable engagement of sunglasses 130 (or 30) with eyeglasses 10.

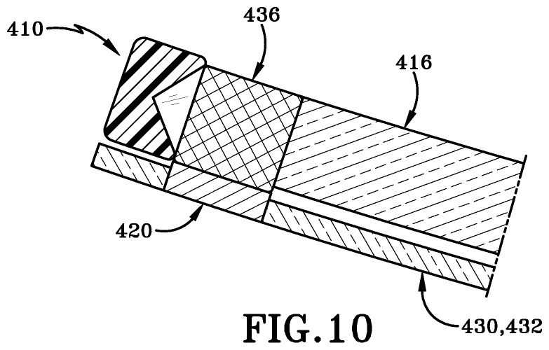

FIG. 10 illustrates the fact instead of the magnets being provided in the eyeglasses and the rods being provided in the sunglasses, the materials may be reversed. In other words, the rods (non-magnetic material) may be provided in the eyeglasses and the magnets may be provided in sunglasses. FIG. 10 shows a portion of a lens 416 of eyeglasses 410 which has a non-magnetic rod 436 therein and a portion of a lens 432 of sunglasses 430 which has a magnet 420 therein. The sunglasses 430 are retained in engagement with the eyeglasses 410 by the attraction between the magnet 420 and stainless steel rod 436. The attraction is indicated in FIG. 8A by the arrows “F”.

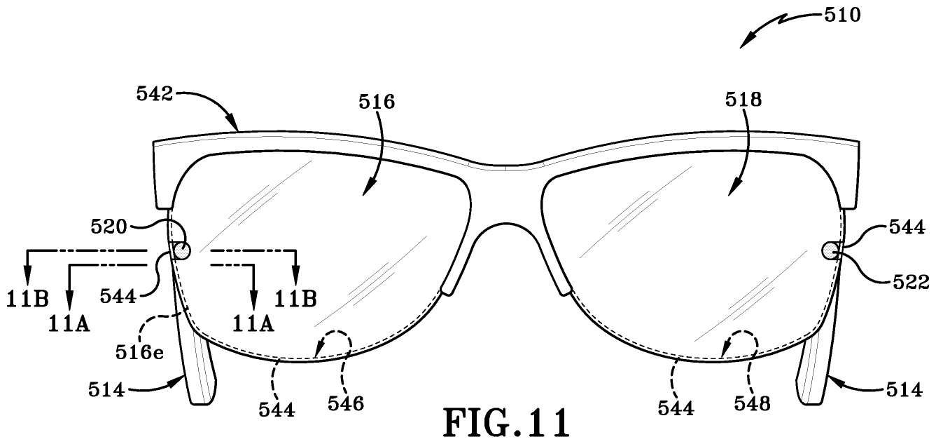

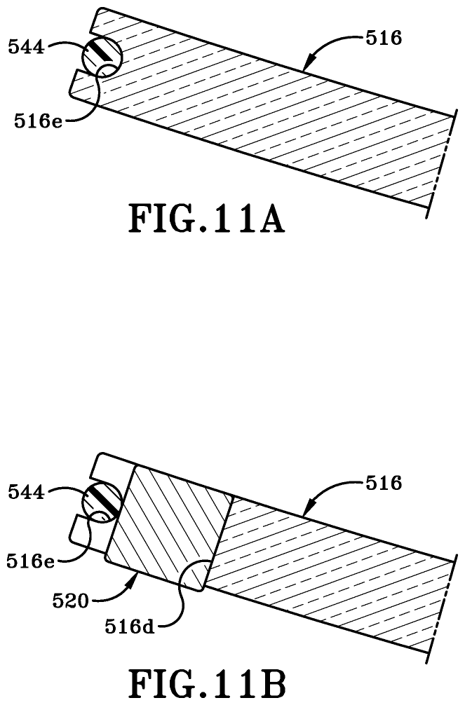

Referring now to FIGS. 11-11B, a further embodiment of eyeglasses is illustrated, generally indicated at 510. Eyeglasses 510 as illustrated include what is are known as a NYLOR® frame. (NYLOR® is a registered trademark of Nylor of Gif-sur-yvette, FRANCE). In this type of eyeglasses, a full frame, such as frame 12 of eyeglasses 10, is replaced with a frame member 542 and a nylon line 544. Together, the frame member 542 and nylon line 544 bound and define two apertures 546 and 548 into which are received a first lens 516 and a second lens 518. Each of the lenses 516 and 518 of eyeglasses 510 are substantially identical to lenses 16, 18 except for the characteristics described hereafter. Each lens 516, 518 defines a notch 516d, 518d into which a magnet 520, 522 (or first or second rod), respectively, is received. As is illustrated in FIGS. 11A and 11B, the first lens 516 (and similarly the second lens 518) is configured to defined a channel 516e in the peripheral edge 516c thereof. The channel 516e extends at least around a first side, a second side, and a bottom end of the first lens 516. The channel 516e may additional extend along a top end of the first lens 516 but in other embodiments the channel may not be defined in the top end of the first lens 516 and the top end will simply be secured to the frame member 542 in any known manner. A similar arrangement exists with second lens 518. Channel 516e is specifically configured to be complementary to at least a portion of the circumferential surface of the nylon line 544. FIGS. 11A and 11B show the nylon line 544 received in channel 516e of first lens 516. In this particular style of eyeglasses 510, the magnets 520, 522 (or rods) are retained within lenses 516, 518 by a combination of friction and the nylon line 544 pinching or squeezing the magnets 520, 522 inwardly in contact with the lens material defining notches 516d, 518d. Eyeglasses 510 are used in the same manner as eyeglasses 10 and all aspects of the structure and function of eyeglasses 510 and sunglasses 30, 130, as described earlier herein, are applicable to eyeglasses 510.

It will be understood that the components utilized in the presently disclosed method may be off-the-shelf products. The components do not need to be specially manufactured in order to work the present disclosure. The use of off-the-shelf products helps reduce the cost involved to enable sunglasses to be engaged with eyeglasses.

Furthermore, the present methodology can be used to retrofit an existing or new sunglasses to a new or existing eyeglasses. Alternatively, the methodology may be performed on a newly ordered eyeglasses and/or eyeglasses. The present methodology may furthermore be performed without a specific software program on regular lens edging equipment or milling machines and requires minimal tools. For example, a punch is able to be utilized to form the notches in the eyeglass lenses. Because the notches 16d, 18d, originate in the peripheral edge 16c, 18c of the associated lens 16, 18 and extend inwardly therefrom for a distance, the positioning of the one of the magnetic member and the non-magnetic member in the eyeglass lenses is less obtrusive than it otherwise could be. Because the one of the magnetic member and the non-magnetic member is adjacent the peripheral edge 16c, 18c of the associate lens there is little to no impact on a person's vision through the lenses.

It will further be understood that if a person decides to purchase a new eyeglasses and/or a new sunglasses, the magnetic members and/or non-magnetic members may be removed from an old eyeglasses or sunglasses and may be readily installed in the new glasses. In other words, the magnetic members and/or non-magnetic members may be reused.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An eyewear assembly comprising:
primary lenses;
secondary lenses;
a connector assembly detachably securing the primary lenses and the secondary lenses to one another;
wherein the connector assembly comprises:
a magnetic member provided in one of the primary lenses and the secondary lenses; and
a non-magnetic member provided in the other of the primary lenses and the secondary lenses.

2. The eyewear assembly according to claim 1, wherein the non-magnetic member is comprised of a material which is attractable to the magnetic member.

3. The eyewear assembly according to claim 2, wherein the material is a metal.

4. The eyewear assembly according to claim 3, wherein the metal is stainless steel.

5. The eyewear assembly according to claim 1, wherein a region of the magnetic member extends outwardly beyond a surface of an associated lens of the one of the primary lenses and the secondary lenses.

6. The eyewear assembly according to claim 1, wherein a region of the non-magnetic member extends outwardly beyond a surface of an associated lens of the other of the primary lenses and the secondary lenses.

7. The eyewear assembly according to claim 1, wherein, when the secondary lenses are operatively engaged with the primary lenses, an end surface of the magnetic member in the one of the primary lenses and the secondary lenses contacts an end surface of the non-magnetic member in the other of the primary lenses and the secondary lenses.

8. The eyewear assembly according to claim 7, further comprising a space defined between an outer surface of the lens of the primary lenses and an inner surface of the lens of the secondary lenses.

9. The eyewear assembly according to claim 1, wherein a notch originates in a peripheral edge of the lens of the primary lenses and the one of the magnetic member and the non-magnetic member is received in the notch.

10. The eyewear assembly according to claim 9, wherein the notch extends between an outer surface and an inner surface of the lens of the primary lenses.

11. The eyewear assembly according to claim 9, wherein a region of a wall of the lens which defines the notch is complementary in configuration to a portion of a circumferential surface of the one of the magnetic member and the non-magnetic member received in the notch.

12. The eyewear assembly according to claim 9, further comprising a securement mechanism provided on the primary lenses, wherein the securement mechanism retains the one of the magnetic member and the non-magnetic member in the notch.

13. The eyewear assembly according to claim 12, wherein the securement mechanism comprises a portion of a frame of the primary lenses.

14. The eyewear assembly according to claim 12, wherein the securement mechanism comprises a length of a nylon wire provided on the primary lenses.

15. The eyewear assembly according to claim 1, wherein an aperture extends between an outer surface and an inner surface of the lens of the secondary lenses, wherein the aperture is located a distance inwardly away from a peripheral edge of the lens of the secondary lenses, and wherein the other of the magnetic member and the non-magnetic member is received in the aperture.

16. A method comprising:
providing primary lenses including at least one eyeglass lens;
providing secondary lenses including at least one sunglass lens;
providing a magnetic member;
providing a non-magnetic member;
installing one of the magnetic member and the non-magnetic member on the at least one eyeglass lens;
installing the other of the magnetic member and the non-magnetic member on the at least one sunglass lens;
attracting the non-magnetic member to the magnetic member; and
retaining the secondary lenses to the primary lenses.

17. The method according to claim 16, further comprising:
defining a notch in the at least one eyeglass lens;
defining an aperture in the at least one sunglass lens;
installing he one of the magnetic member and the non-magnetic member in the notch defined in the at least one eyeglass lens; and
installing the other of the magnetic member and the non-magnetic member in the aperture defined in the at least one sunglass lens.

18. The method according to claim 16, further comprising:
moving the secondary lenses and primary lenses into close proximity with one another; and
aligning the magnetic member in the one of the primary lenses and the secondary lenses with the non-magnetic member in the other of the primary lenses and the secondary lenses.

19. The method according to claim 18, further comprising bringing the magnetic member and the non-magnetic member into direct contact with one another.

20. The method according to claim 16, wherein providing the non-magnetic member includes providing a rod of stainless steel capable of being attracted to a magnet.
